(19) United States
(12) Patent Application Publication
(10) Pub. No.: US 2019/0266474 A1
(43) Pub. Date: Aug. 29, 2019

(54) Systems And Method For Character Sequence Recognition

(71) Applicant: SAP SE, Walldorf (DE)

(72) Inventors: Michael Stark, Bellevue, WA (US); Jesper Lind, Bellevue, WA (US); Everaldo Aguiar, Bellevur, WA (US); Catherine Nelson, Palo Alto, CA (US)

(73) Assignee: SAP SE, Walldorf (DE)

(21) Appl. No.: 15/907,248

(22) Filed: Feb. 27, 2018

(51) Int. Cl. G06N 3/04; G06N 3/08

(52) U.S. Cl. CPC G06N 3/0445; G06N 3/08; G06N 3/0454

(57) ABSTRACT

Embodiments of the present disclosure pertain to character recognition using neural networks. In one embodiment, the present disclosure includes a computer implemented method comprising processing a plurality of characters using a first recurrent machine learning algorithm. The first recurrent machine learning algorithm sequentially produces a first plurality of internal arrays of values. The first plurality of internal arrays of values are stored to form a stored plurality of arrays of values. The stored plurality of arrays of values are multiplied by a plurality of attention weights to produce a plurality of selection values. An attention array of values is generated from the stored arrays based on the selection values. The attention array of values is processed using a second recurrent machine learning algorithm, the second recurrent machine learning algorithm produces a recognized character sequence.

### BACKGROUND

The present disclosure relates to computing, and in particular, to character sequence recognition using neural networks.

Advances in computing technology have led to the increased adoption of machine learning (aka artificial intelligence) across a wide range of applications. One challenge with machine learning is that data typically requires complex preprocessing steps prior to prepare the data for analysis by a machine learning algorithm. However, for some types of data inputs, it may be desirable and more efficient to have a machine learning algorithm that can process batches of data inputs with a minimum, or completely without, any computationally intensive preprocessing while still yielding accurate results. One example data set that could benefit from such a system would be data corresponding to receipts.

### SUMMARY

Embodiments of the present disclosure pertain to character recognition using neural networks. In one embodiment, the present disclosure includes a computer implemented method comprising processing a plurality of characters using a first recurrent machine learning algorithm, such as a neural network, for example. The first recurrent machine learning algorithm sequentially produces a first plurality of internal arrays of values. The first plurality of internal arrays of values are stored to form a stored plurality of arrays of values. The stored plurality of arrays of values are multiplied by a plurality of attention weights to produce a plurality of selection values. An attention array of values is generated from the stored arrays based on the selection values. The attention array of values is processed using a second recurrent machine learning algorithm, the second recurrent machine learning algorithm produces values corresponding to characters of the plurality of characters forming a recognized character sequence.

The following detailed description and accompanying drawings provide a better understanding of the nature and advantages of the present disclosure.

### BRIEF DESCRIPTION OF THE DRAWINGS

FIG. 1 illustrates character recognition using recurrent neural networks according to one embodiment.

FIG. 2 illustrates a neural network recognition process according to an embodiment.

FIG. 3 illustrates character recognition using recurrent neural networks according to another embodiment.

FIG. 4 illustrates an example recurrent neural network system according to one embodiment.

FIG. 5 illustrates another neural network recognition process according to an embodiment.

FIG. 6 illustrates computer system hardware configured according to the above disclosure.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

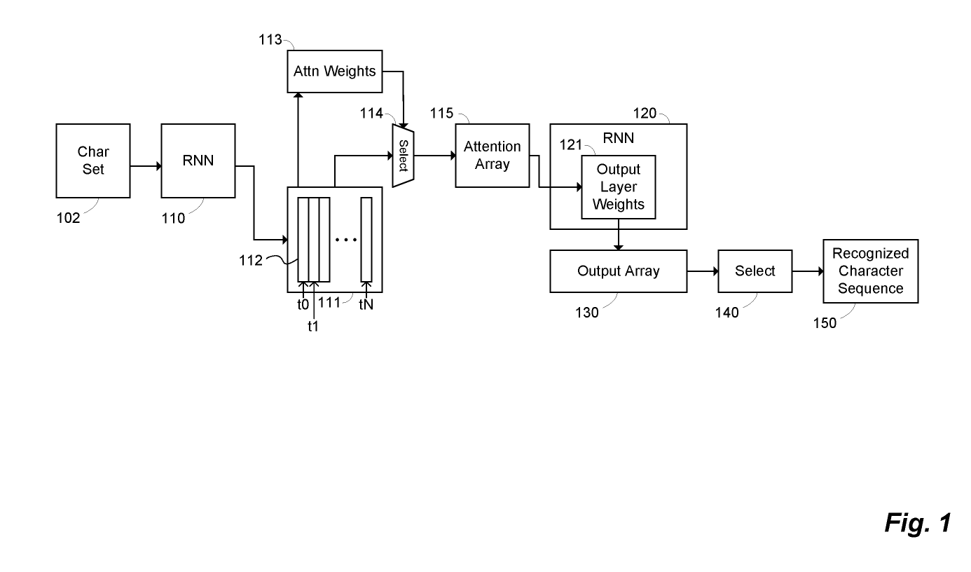

FIG. 1 illustrates character recognition using recurrent neural networks according to one embodiment. Features and advantages of the present disclosure include recognizing elements of a corpus of characters (i.e., char set 102) using recurrent neural networks. A first recurrent neural network 110 may process characters to produce a plurality of output arrays of values 112. The arrays of values 112 generated by the first recurrent neural network 110 may be stored and multiplied by attention weights 113 to produce attention arrays of values 115 to be used in producing an input for a second recurrent neural network 120. The second recurrent neural network 120 may include an output layer 121 with weights, where the second recurrent neural network 120 produces values corresponding to input characters that form a recognized character sequence 150. One example application is in the area of receipt recognition. It may be desirable in some applications to recognize the total cost of a transaction specified in a receipt (e.g., from dinner, a market, or the like). Using the techniques described herein, a corpus of characters from a receipt may be processed by series configured recurrent neural networks to automatically recognize a character sequence corresponding to the total price of the transaction (e.g., $3.14, $256.25 or the like), for example. Of course, other embodiments may recognize other aspects of other corpuses of characters, for example.

Referring again to FIG. 1, in one embodiment a plurality of characters may be processed using a recurrent neural network (“RNN”) 110. The characters may be represented in a computer using a variety of techniques. For example, in one embodiment, each character in a character set (e.g., a . . . z, A . . . Z, 0 . . . 9, as well as special characters such as $, &, @, and the like) may be represented by an array, where one element of the array is non-zero, and the remaining values in the array are zero. Different non-zero positions in the array may correspond to different characters. As an illustrative example, the character “a” may be represented by [1, 0, 0, . . . , 0], the character “H” may be represented by [0, . . . , 0, 1, 0, . . . , 0], and the character “9” may be represented by [0, . . . , 0, 1, 0, . . . , 0], where the one (1) for the “H” and the “9” are in different positions that correspond to different characters, for example. These and other arrays of values corresponding to encoded characters are referred to herein as “encoded character arrays.”

Generally, a recurrent neural network is a type of neural network that employs one or more feedback paths (e.g., directed cycles). RNN 110 may have a single layer of weights that are multiplied by an input array, and combined with a result of an internal state array multiplied by feedback weights, for example. An internal state may be updated by combining the weighted sums with a bias as described in more detail below, for example. Accordingly, the output of RNN 110 may sequentially produce a plurality of internal arrays of values (e.g., one for each character received on the input). Features and advantages of the present disclosure include storing the plurality of internal arrays of values from RNN 110 generated during processing of characters to form a stored plurality of arrays of values 112 in memory 111. For example, when a first encoded character array corresponding to a first character from character set 102 is provided to the input of RNN 110, then a first resulting update will occur to an internal state of the RNN 110. A first internal array of values, updated in response to receiving an encode character array on the input of RNN 110, may be stored in memory 111. This first stored array may be denoted as being received at time t0. On a subsequent cycle, the next encoded character array is provided at the input of RNN 110. Accordingly, the internal array in RNN 110 is updated with a new set of values, and the new internal array of values may be stored in memory 111 as t1, for example. Similarly, as each encoded character array representing the characters of the corpus are received, the state of the internal array is stored in memory 111 until all the characters have been processed a tN, at which point N stored arrays of values 112 are in memory 111, where N is an integer representing the integer number of characters in the corpus, for example.

Embodiments of the disclosure include multiplying the stored plurality of arrays of values 112 by a plurality of attention weights 113 to produce a plurality of selection values. Selection values may be used for selecting particular stored arrays of values 112 in memory 111 as inputs to RNN 120. The attention weights 113 may be configured (e.g., during training) to produce selection values comprising a plurality of zero (0), or nearly zero, selection values and one or more non-zero selection values. As an illustrative example, selection values may ideally be as follows: [0,0,0, . . . , 1, . . . , 0,0], where the position of the one (1) in the array is used to select one of the stored arrays of values 112. Accordingly, the number of selection values may be equal to the number of stored arrays of values 112 in memory 111. For example, an array of selection values of [0, 1, 0, . . . , 0] would select stored array t1 (e.g., the second array of values received from RNN 110). Accordingly, one or more of the stored arrays of values 112 may be selected based on the selection values to produce an attention array of values. In some embodiments, selection values may range continuously from 0-1, for example, where stored arrays 112 having corresponding selection values are selected to produce attention arrays input to RNN 120, for example.

In some embodiments, multiplying each stored array of values 112 by attention weights 113 may produce a single selection value (e.g., nearly 1), and one of the stored arrays 112 is selected as an input for RNN 120. For example, after N stored arrays 112 are multiplied by attention weights 113, each of the resulting N values may be zero or nearly zero, and only one selection value may be nearly one (1). For instance, an example of N selection values may be [0.001, 0.023, . . . , 0.95], where the last value in the array is substantially greater than the other near zero values in the array. In this case, last stored array tN is selected and provided as an input to RNN 120, for example. As another example, N selection values may be [0.001, 0.98, . . . , 0.003], where the second value in the array is substantially greater than the other near zero values in the array. In this case, second stored array t1 is selected and provided as an input to RNN 120, for example.

In other embodiments, multiplying each stored array of values 112 by attention weights 113 may produce multiple selection values across a range of values. In some embodiments, the plurality of the largest selection values may be adjacent selection values and correspond to adjacent stored arrays of values 112. For instance, an example of N selection values may be [0.001, 0.023, . . . , 0.25, 0.5, 0.24], where the last 3 values are adjacent to each other in the array and substantially greater than the other near zero values in the array, for example. In one embodiment, each selection value above the threshold is multiplied by a corresponding array of values in the stored arrays of values 112 to produce a plurality of weighted arrays. The weighted arrays may be added to produce an attention array of values 115, which is then provided as an input to RNN 120, for example. For example, for N selection values, where the i−1, i, and i+1 selection values are [ . . . , 0.25, 0.5, and 0.25, . . . ], and where the corresponding i−1, i, and i+1 stored arrays are [Ati−1], [Ati], and [Ati+1] (where Ati is the ith stored array 112 and i=0 . . . N), then the attention array is determined by matrix multiplication and addition as follows:

[attention array]=[Ati−1]*0.25+[Ati]*0.5+[Ati+1]*0.25

In one embodiment, the selection values add to one (1), and selection comprises multiplying each stored array by a corresponding selection value, and adding the weighted arrays as above to produce the attention array of values. In this case, since many selection values may be very small, the sum of stored arrays weighted by corresponding selection values may produce an attention array that is approximately equal to one stored array or a sum of multiple stored arrays weighted by their selection values, for example. More specifically, in one embodiment, all the selection values are multiplied by their corresponding stored array vector and added together to create a weighted sum of all the stored vectors. In some embodiments, the selection values will mostly be very near 0 and one stored array may be near one (1) or a few may have non-zero values that add to almost 1. Some embodiments may apply a threshold at this point to use a subset of selection values, for example. However, other embodiments may use all selection values as follows. If, for example, arrays T0-T4 are created by the input RNN 110, and the selection values are [0,01, 0.05, 0.5, 0.4, 0.04] calculated by the attention model applied to T0-T4, where the selection values sum of 1, then the output would be:

Tout=0.01*T0+0.05*T1+0.5*T2+0.4*T3+0.04*T4,

Where Tout is the attention array and the above weighted sum is performed element-wise. If each array, T, is 3 elements and there are 5 arrays, T0-T4 may be concatenated here into a matrix:

| T0 | T1 | T2 | T3 | T4 |
|---|---|---|---|---|
| 1 | 2 | 3 | 4 | 5 |
| 5 | 4 | 3 | 2 | 1 |
| 3 | 2 | 1 | 2 | 3. |

Then Tout may be calculated as follows, where the three values for the Tout vector are on the right, on the left is the resulting calculation of the attention array, for example:

0.01*1+0.05*2+0.5*3+0.4*4+0.04*5=3.41

0.01*5+0.05*4+0.5*3+0.4*2+0.04*1=2.59

0.01*3+0.05*2+0.5*1+0.4*2+0.04*3=1.55.

Attention array of values 115 may be processed using RNN 120 to produce values corresponding to characters from the character set 102 forming a recognized character sequence 150. In one embodiment, RNN 120 may include output layer weights 121. Output layer weights 121 may comprise a matrix of values (N×M) that operate on a second plurality of internal arrays of values in RNN 120, for example. Attention array 115 may be processed by RNN 120 to successively produce the internal arrays of values, which are then provided as inputs to the output layer weights, for example. In one embodiment, the attention array of values 115 is maintained as an input to RNN 120 for a plurality of cycles. The number of cycles may be arbitrary. The RNN may continue until the output is a STOP character. In one example implementation, a maximum possible output length may be selected (e.g., 5 characters for a date {DDMM} and 13 for an amount) and always run the RNN for that many cycles, only keeping the output before the STOP character in the output.

RNN 120 produces a plurality of output arrays 130. The output arrays may comprise likelihood values, for example. In one embodiment, a position of each likelihood value in each of the output arrays may correspond to a different character found in the character set, for example. A selection component 140 may receive the output arrays of likelihoods, for example, and successively produce a character, for each output array, having the highest likelihood value in each of the output arrays, for example. The resulting characters form a recognized character sequence 150, for example.

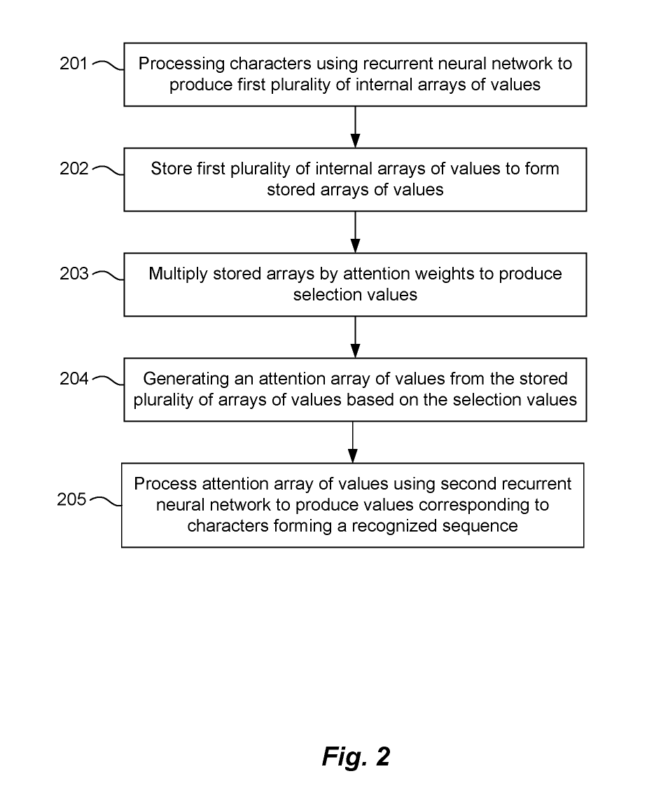

FIG. 2 illustrates a neural network recognition process according to an embodiment. At 201, a plurality of characters are processed using a first recurrent neural network. The first recurrent neural network sequentially produces a first plurality of internal arrays of values, for example, as each character is processed. At 202, the first plurality of internal arrays of values are stored in memory to form a stored plurality of arrays of values. At 203, the stored plurality of arrays of values are multiplied (e.g., matrix multiplication or dot product) by a plurality of attention weights to produce a plurality of selection values. The selection values may include one or more selection values, for example. At 204, an attention array of values is generated from the stored plurality of arrays of values based on the selection values. As mentioned above, the attention array of values may be approximately equal to one of the stored plurality of arrays of values, or alternatively, the attention array of values may be approximately equal to a sum of a plurality of stored arrays of values (e.g., adjacent stored arrays) each multiplied by corresponding selection values. At 205, the attention array of values is processed using a second recurrent neural network. The second recurrent neural network may produce values corresponding to characters to form a recognized character sequence.

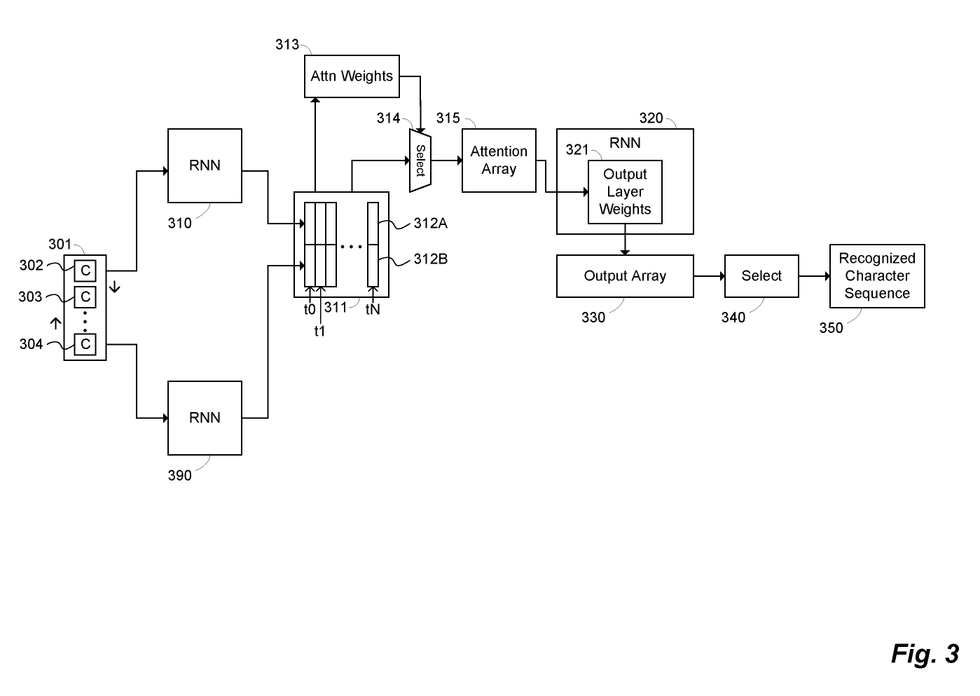

FIG. 3 illustrates character recognition using recurrent neural networks according to another embodiment. In one embodiment, characters from a character set 301 may be provided as inputs to two recurrent neural networks 310 and 390 in reverse order. For example, characters in character set 301 may have an ordering. For example, character 302 may be in a first position, character 303 may be in a second position, etc. . . . , and character 304 may be in an Nth position, where N is an integer number of total characters in character set 301. In one embodiment, characters may be provided to RNN 310 in order (i.e., char1, char2, char3, . . . , charN). In this example, while the characters from character set 301 are being provided to the input of RNN 310, other characters from character set 301 are being provided to a second RNN 390. The characters provided to RNN 390 may be received in a reverse order relative to the processing of characters using RNN 310 (e.g., charN, charN−1, . . . , char3, char2, char1). As mentioned above, RNN 310 may sequentially produce a first plurality of internal arrays of values as each character is received and processed. The first internal arrays of values from RNN 310 are then placed in memory 311 to form a stored plurality of arrays of values. Similarly, RNN 390 sequentially produces a second plurality of internal arrays of values as each character is received and processed. In this example embodiment, the second plurality of internal arrays of values from RNN 390 are then placed in memory 311 with the stored plurality of arrays of values. Thus, arrays of internal values from RNNs 310 and 390 produced at the same time are stored together in the stored plurality of arrays of values as illustrated at 312A and 312B. As a specific example, at t0 RNN 310 may produce a first internal array of values [x1, . . . xR], where R is an integer, and RNN 390 may produce a second internal array of values [y1, . . . , yR]. Accordingly, the first stored array of values would be [x1 . . . xR,y1 . . . yR]. Similar arrays of values are stored at t1 through tN, for example. Processing characters in a character set using two RNNs as shown above may advantageously improve the accuracy of the results, for example.

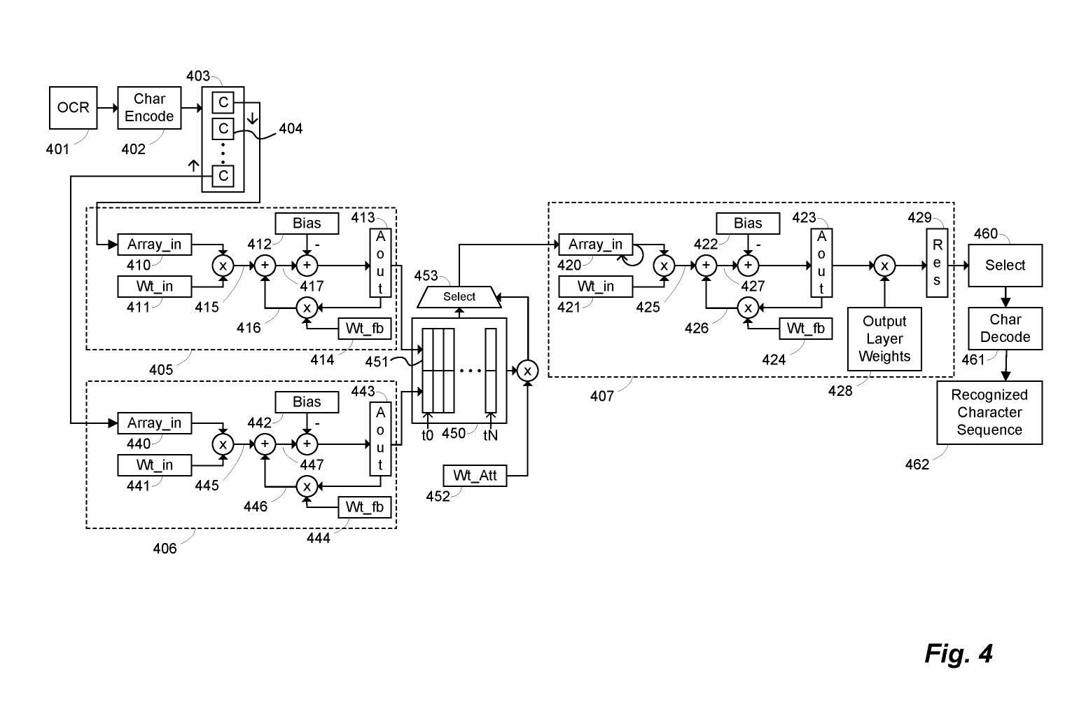

FIG. 4 illustrates an example recurrent neural network system according to one embodiment. In this example, a plurality of characters are received from an optical character recognition system (OCR) 401. OCR 401 may be used to produce a wide range of character sets. In one example embodiment, the character set corresponds to a transaction receipt, for example, but the techniques disclosed herein may be used for other character sets. As mentioned above, the characters may be encoded so that different characters within the character set are encoded differently. Coding may be performed by OCR 401 or by a character encoder 402. For example, a character set may include upper and lower case letters, numbers (0-9), and special characters, each represented using a different character code. In one example encoding, each type of character in the character set (e.g., A, b, Z, f, $, 8, blank spacec, etc. . . . ) has a corresponding array, and each array comprises all zeros and a single one (1) value. For example, the word “dad” may be represented as three arrays as follows:

d=[0,0,0,1,0, . . . , 0]; a=[1,0, . . . , 0]; d=[0,0,0,1,0, . . . , 0].

In the example in FIG. 4, the encoded character arrays are ordered. For example, characters for a receipt or other readable document may be ordered starting from left to right and top to bottom. Thus, for a character set 403 having a total of N characters, there will be N positions in the character set. In this example, there are N encoded character arrays 404 in character set 403, which are ordered 1 . . . N. Character arrays 404 may be provided as inputs to two RNNs 405 and 406, where RNN 405 receives the character arrays 404 in order 1 . . . N and RNN 406 receives the character arrays in reverse order N . . . 1, for example.

In this example, RNN 405 receives an input array of values (“Array_in”) 410 corresponding to successive characters. Input arrays 410 are multiplied by a plurality of input weights (“Wt_in”) 411 to produce a weighted input array of values at 415, for example. RNN 405 includes an internal array of values (“Aout”) 413, which are multiplied by a plurality of feedback weights (“Wt_fb”) 414 to produce a weighted internal array of values at 416. The weighted input array of values at 415 is added to the weighted internal array of values at 416 to produce an intermediate result array of values at 417. A bias array of values 412 may be subtracted from the intermediate result array of values at 417 to produce an updated internal array of values 413, for example. The internal array of values 413 are also stored in memory 450 to generate stored arrays of values 451.

Similarly, RNN 406 receives an input array of values (“Array_in”) 440 corresponding to successive characters received in reverse order relative to RNN 405. Input arrays 440 are multiplied by a plurality of input weights (“Wt_in”) 441 to produce a weighted input array of values at 445, for example. RNN 406 includes an internal array of values (“Aout”) 443, which are multiplied by a plurality of feedback weights (“Wt_fb”) 444 to produce a weighted internal array of values at 446. The weighted input array of values at 445 is added to the weighted internal array of values at 446 to produce an intermediate result array of values at 447. A bias array of values 442 may be subtracted from the intermediate result array of values at 447 to produce an updated internal array of values 443, for example. The internal array of values 443 are also stored in memory 450 with internal array of values 413 to generate stored arrays of values 451.

Stored arrays of values 451 are multiplied by attention weights 452 to generate selection values. If each character in the corpus of characters 403 is represented as M values in each input array 410 and 440, then there are also M internal values in each internal array generated by RNN 405 and M internal values in each internal array generated by RNN 406. Accordingly, stored arrays 451 in memory 450 are of length 2*M, for example. For N characters in the corpus, each RNN 405 and 406 may generate N stored arrays of length M, for example. To select particular arrays from the N stored internal array of 2*M-values, N selection values may be generated, for example, by determining the dot product of each stored array 451 with 2*M attention weights (“Wt_att”) 452, for example. More particularly, the dimensions of the attention weights 452 may be Mx1, and each of the 2*M-length stored internal values is multiplied by an Mx1 weight set to generate a single value for each of the 2*M-length arrays. The N selection values may be stored in another selection array, for example. After generating a single selection value for all the N stored arrays 451, the array of N selection values may be used to select one or more of the N stored arrays 451.

In an ideal case, the N selection values may be all zeros and only a single one (e.g., [0 . . . 1 . . . 0]) to select the one stored array producing the non-zero selection value, for example. In one example implementation, all but one of the selection values may be near zero, and a single selection value is closer to one. The selection value closer to one corresponds to the desired stored array of values 451 that is sent to the second stage RNN 407. In other instances, multiple selection values may have high values and the remaining selection values nearly zero values. In this case, the selection values with higher values correspond to the desired stored arrays of values 451, each of which is multiplied by the corresponding selection value. The selected stored arrays from 451, having now been weighted by their selection values, are added to form the attention array sent to the input of second stage RNN 407. In one embodiment, characters 403 are processed by one or more first stage RNNs and stored in memory before performing the selection step described above and before the processing the attention array of values using a second stage RNN, for example.

In one embodiment pertaining to recognizing dates or amounts in a corpus of characters from receipts, the first RNN layer learns to simultaneously encode the date or amount in stored output array as well as a signal to the attention layer indicating a confidence that the correct amount or date has been encoded. For example, the amount may be encoded in one part of the stored array and the signal to the attention layer may be encoded in an entirely separate part of the array, for example.

RNN 407 receives an attention array as an input array (“Array_in”) 420. Similar to RNNs 405 and 406, input arrays 420 are multiplied by a plurality of input weights (“Wt_in”) 421 to produce a weighted input array of values at 425, for example. RNN 407 includes an internal array of values (“Aout”) 423, which are multiplied by a plurality of feedback weights (“Wt_fb”) 424 to produce a weighted internal array of values at 426. The weighted input array of values at 425 is added to the weighted internal array of values at 426 to produce an intermediate result array of values at 427. A bias array of values 422 may be subtracted from the intermediate result array of values at 427 to produce an updated internal array of values 423, for example. The internal array of values 423 are then combined with output layer weights 428, to produce result output arrays 429. To produce multiple result arrays, the attention array forming the input array 420 to RNN 407 is maintained as an input to RNN 407 for a plurality of cycles. During each cycle, the weighted attention array at 425 may be combined with new weighted internal arrays at 426 and bias 422 to generate multiple different internal arrays 423. On successive cycles, new internal array values 423 may be operated on by output layer weights 428 to produce new result array values, for example. As mentioned above, the output RNN may run for the number of cycles in the output string until it generates the STOP character or, for efficiency of the calculation, an arbitrary number of cycles based on the expected maximum length of the output, for example.

As mentioned above, in this example implementation, there may be 2*M values in the attention array generated by the selection process and provided as an input to RNN 407. Accordingly, there may be 2*M internal values in internal array 423. In one embodiment, output layer weights 428 may be an M×2M matrix of weight values to convert the 2*M internal values in array 423 into M result values, where each character in the corpus of characters 403 is represented as M values. Thus, each of the M values in the result array corresponds to one character. In one embodiment, RNN 407 successively produces a plurality of result output arrays of likelihood values. For example, a position of each likelihood value in each of the result output arrays corresponds to a different character of the plurality of characters. Accordingly, the system may successively produce a character having a highest likelihood values in each of the output arrays. In this example, for each result output array of likelihood values, a character corresponding to the highest likelihood value in each array may be selected at 460. Accordingly, encoded character arrays generated from sequential result output arrays 429, as described above at the input of RNNs 405 and 406 may be decoded at 461 to produce a recognized character sequence 462, for example.

In one example embodiment, there may be N characters in a corpus. Each character may be represented by an encoded character array of length 128, where each character type in the character set has a corresponding array of all zeros and a single one, for example. Accordingly, the input arrays of each RNN 405 and 406 are multiplied by 128 input weights. Similarly, the internal values 413 and 443 are arrays of length 128, which are each multiplied by 128 feedback weights. The combined internal arrays of 128 values from RNN 405 and 406 produce N stored arrays of 256 values each. These N stored arrays (one for each character) are multiplied by 256 attention weights to produce N selection values, for example. The selection process produces an attention array of length 256, which is provided as an input array to RNN 407. RNN 407 may have an internal array length of 256 values. Thus, output layer weights are a matrix of 128×256 to produce 128 length result output arrays of likelihoods, for example, where each position in the output array corresponds to a particular character.

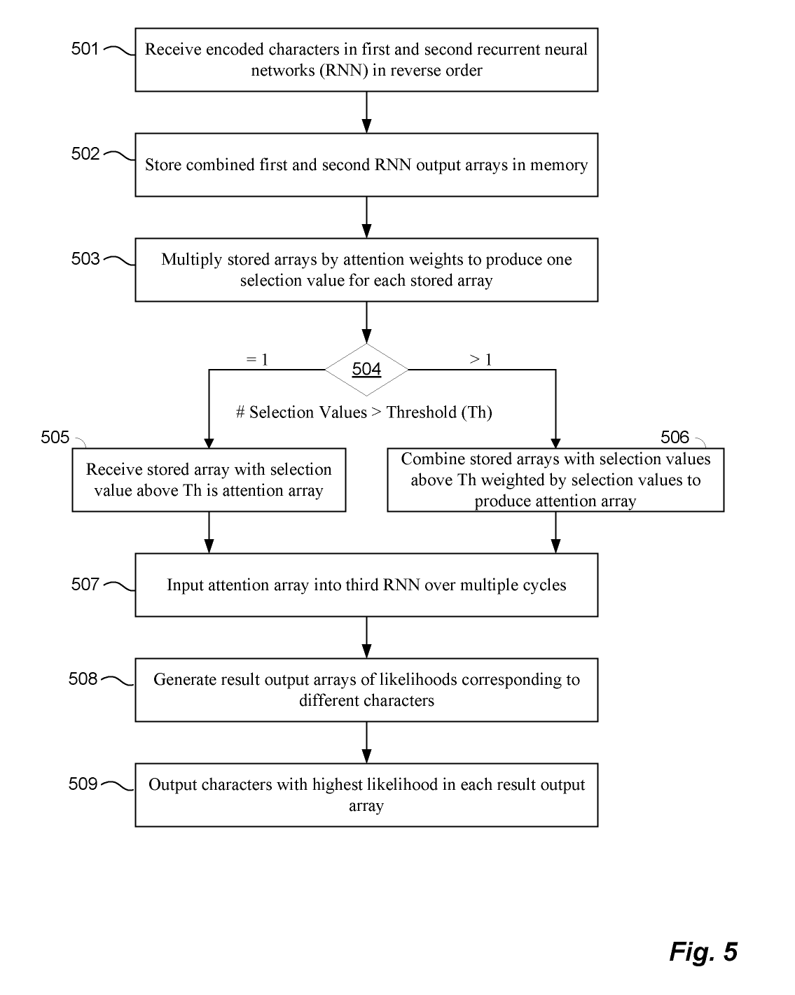

FIG. 5 illustrates another neural network recognition process according to an embodiment. In this example, encoded characters are received in first and second RNNs in reverse order at 501. At 502, first and second RNN output arrays are combined and stored in memory. At 503, the stored arrays are multiplied by attention weights to produce one selection value for each stored array, for example. At 504, different steps may occur based on the selection values. In this example, if there is only a single selection value above a threshold (=1) then the stored array with the selection value above the threshold becomes an attention array. If there is more than one selection value above a threshold (>1), then the stored arrays are combined with selection values above the threshold and weighted by the selection values to produce the attention array. As described above, selection may alternatively involve multiplying all the stored arrays by their corresponding selection values and adding the result to produce an attention array. At 507, the attention array is input into a third RNN over multiple cycles, for example. At 508, result output arrays of likelihoods corresponding to different characters are generated by the third RNN. The third RNN may include an output layer to map the input attention arrays to a result output array having a length equal to the number of different character types, for example. At 509, characters with the highest likelihood in each result output array are output, for example, over multiple cycles to produce a recognized character sequence.

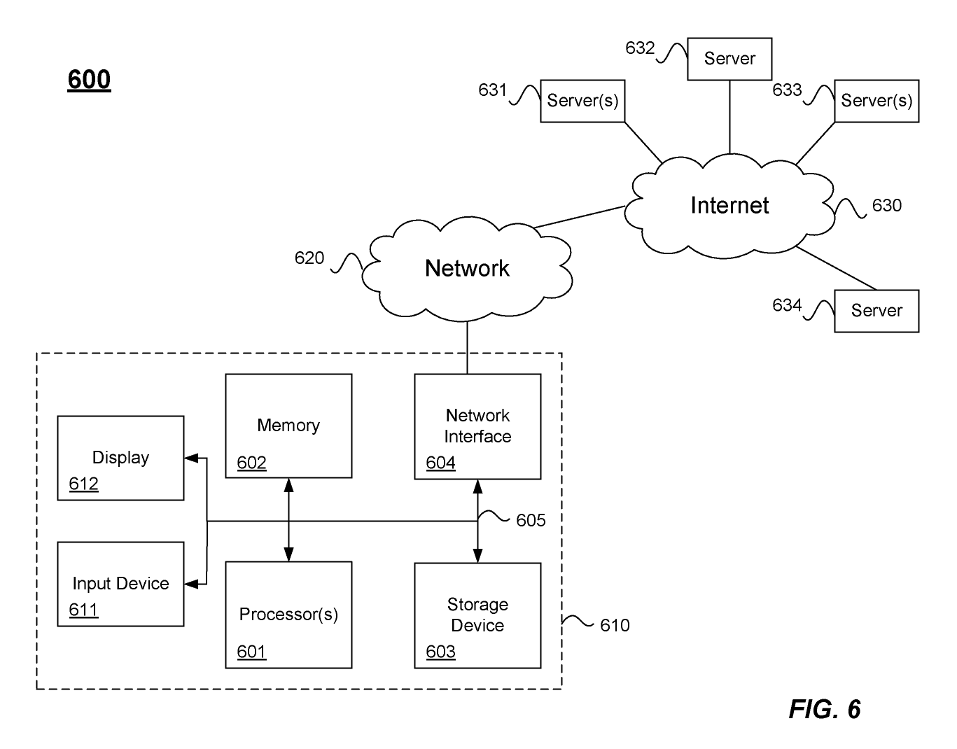

FIG. 6 illustrates computer system hardware configured according to the above disclosure. The following hardware description is merely one illustrative example. It is to be understood that a variety of computers topologies may be used to implement the above described techniques. An example computer system 610 is illustrated in FIG. 6. Computer system 610 includes a bus 605 or other communication mechanism for communicating information, and one or more processor(s) 601 coupled with bus 605 for processing information. Computer system 610 also includes a memory 602 coupled to bus 605 for storing information and instructions to be executed by processor 601, including information and instructions for performing some of the techniques described above, for example. Memory 602 may also be used for storing programs executed by processor(s) 601. Possible implementations of memory 602 may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 603 may include source code, binary code, or software files for performing the techniques above, for example. Storage device 603 and memory 602 are both examples of non-transitory computer readable storage mediums.

Computer system 610 may be coupled via bus 605 to a display 612 for displaying information to a computer user. An input device 611 such as a keyboard, touchscreen, and/or mouse is coupled to bus 605 for communicating information and command selections from the user to processor 601. The combination of these components allows the user to communicate with the system. In some systems, bus 605 represents multiple specialized buses for coupling various components of the computer together, for example.

Computer system 610 also includes a network interface 604 coupled with bus 605. Network interface 604 may provide two-way data communication between computer system 610 and a local network 620. Network 620 may represent one or multiple networking technologies, such as Ethernet, local wireless networks (e.g., WiFi), or cellular networks, for example. The network interface 604 may be a wireless or wired connection, for example. Computer system 610 can send and receive information through the network interface 604 across a wired or wireless local area network, an Intranet, or a cellular network to the Internet 630, for example. In some embodiments, a browser, for example, may access data and features on backend software systems that may reside on multiple different hardware servers on-prem 631 or across the Internet 630 on servers 632-635. One or more of servers 632-635 may also reside in a cloud computing environment, for example.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A computer implemented method comprising:
processing a plurality of characters using a first recurrent neural network, the first recurrent neural network sequentially producing a first plurality of internal arrays of values;
storing the first plurality of internal arrays of values to form a stored plurality of arrays of values;
multiplying the stored plurality of arrays of values by a plurality of attention weights to produce a plurality of selection values;
generating an attention array of values from the stored plurality of arrays of values based on the selection values; and
processing the attention array of values using a second recurrent neural network, the second recurrent neural network producing values corresponding to characters of the plurality of characters forming a recognized character sequence.

2. The method of claim 1 further comprising:
encoding different characters of the plurality of characters as a plurality of zeros (0) and a single one (1); and
decoding the values corresponding to characters from the output of the second recurrent neural network to produce the recognized character sequence.

3. The method of claim 1 wherein the selection values comprise one selection value greater than a threshold for selecting one of the stored plurality of arrays of values.

4. The method of claim 1 wherein the attention array of values is approximately equal to one of the stored plurality of arrays of values.

5. The method of claim 1 wherein the attention array of values is approximately equal to a sum of a plurality of adjacent stored arrays of values each multiplied by corresponding selection values.

6. The method of claim 1 wherein the selection values comprise a plurality of selection values, the generating the attention array step further comprising:
multiplying each selection value by a corresponding array of values in the stored plurality of arrays of values to produce a plurality of weighted arrays; and
adding the weighted arrays to produce the attention array of values.

7. The method of claim 1 wherein, as each character is processed by the first neural network, the output of the first recurrent neural network produces a new internal array of values of the first plurality of internal arrays of values, and in accordance therewith, the stored plurality of arrays of values correspond to particular characters of the plurality of characters.

8. The method of claim 1 wherein the plurality of characters are N characters, the stored plurality of arrays of values comprise N arrays each having M values, and the plurality of attention weights comprise M attention weights, wherein each of the stored N arrays of M values is multiplied by the M attention weights to produce N selection values, where N and M are integers.

9. The method of claim 1 wherein each of the plurality of selection values are between zero (0) and one (1).

10. The method of claim 1 wherein the plurality of characters are processed by the first recurrent neural network before performing the generating the attention array step and before the processing the attention array of values using the second recurrent neural network step.

11. The method of claim 1 wherein the attention array of values is maintained as an input to the second recurrent neural network for a plurality of cycles.

12. The method of claim 1 wherein the second recurrent neural network comprises output layer weights operating on a second plurality of internal arrays of values in the second recurrent neural network.

13. The method of claim 12 wherein the first plurality of internal arrays of values are multiplied by first feedback weights to produce a first feedback result in the first recurrent neural network, and wherein the second plurality of internal arrays of values are multiplied by second feedback weights to produce a second feedback result in the second recurrent neural network.

14. The method of claim 1 wherein the second recurrent neural network successively produces a plurality of output arrays of likelihood values, and wherein a position of each likelihood value in each of the output arrays corresponds to a different character of the plurality of characters, the method further comprising successively producing a character having a highest likelihood values in each of the output arrays.

15. The method of claim 1 further comprising processing the characters using a third recurrent neural network in reverse order relative to the processing of characters using the first recurrent neural network, the third recurrent neural network having an output sequentially producing a second plurality of internal arrays of values; and
storing the second plurality of internal arrays of values with the stored plurality of arrays of values, wherein arrays of values from the first and second plurality of arrays of values produced at the same time are stored together in the stored plurality of arrays of values.

16. The method of claim 15, wherein processing the plurality of characters using the first recurrent neural network and the third recurrent neural network comprising:
for each character of the plurality of characters:
receiving an input array of values, the input array of values corresponding to representations of characters of the plurality of characters, wherein different characters of the plurality of characters are represented as a plurality of zeros (0) and a single one (1);
multiplying the input array of values by a plurality of input weights to produce a weighted input array of values;
multiplying an internal array of values of the a first and second plurality of internal arrays of values by a plurality of feedback weights to produce a weighted internal array of values;
adding the weighted input array of values to the weighted internal array of values to produce an intermediate result array of values; and
subtracting a bias array of values from the intermediate result array of values to produce an updated internal array of values.

17. The method of claim 1 wherein the plurality of characters are received from an optical character recognition system and the plurality of characters correspond to a transaction receipt.

18. The method of claim 17 wherein the plurality of characters correspond to the transaction receipt date or amount.

19. A non-transitory machine-readable medium storing a program executable by at least one processing unit of a computer, the program comprising sets of instructions for:
processing a plurality of characters using a first recurrent machine learning algorithm, the first recurrent machine learning algorithm sequentially producing a first plurality of internal arrays of values;
storing the first plurality of internal arrays of values to form a stored plurality of arrays of values;
multiplying the stored plurality of arrays of values by a plurality of attention weights to produce a plurality of selection values;
generating an attention array of values from the stored plurality of arrays of values based on the selection values; and
processing the attention array of values using a second recurrent machine learning algorithm, the second recurrent machine learning algorithm producing values corresponding to characters of the plurality of characters forming a recognized character sequence.

20. A computer system comprising:
a processor; and
a non-transitory machine-readable medium storing a program executable by the processor, the program comprising sets of instructions for:
processing a plurality of characters using a first recurrent neural network, the first recurrent neural network sequentially producing a first plurality of internal arrays of values;
storing the first plurality of internal arrays of values to form a stored plurality of arrays of values;
multiplying the stored plurality of arrays of values by a plurality of attention weights to produce a plurality of selection values;
generating an attention array of values from the stored plurality of arrays of values based on the selection values; and
processing the attention array of values using a second recurrent neural network, the second recurrent neural network producing values corresponding to characters of the plurality of characters forming a recognized character sequence.
